(19) United States
(12) Patent Application Publication
(10) Pub. No.: US 2005/0021577 A1
(43) Pub. Date: Jan. 27, 2005

(54) Applied estimation of eigenvectors and eigenvalues

(76) Inventors: Nagabhushana Prabhu, West Lafayette, IN (US); Wei He, Memphis, TN (US)

Correspondence Address: WOODARD, EMHARDT, MORIARTY, MCNETT & HENRY LLP, BANK ONE CENTER/TOWER, 111 MONUMENT CIRCLE, SUITE 3700, INDIANAPOLIS, IN, 46204-5137, US

(21) Appl. No.: 10/855,174

(22) Filed: May 27, 2004

Related U.S. Application Data
(60) Provisional application No. 60/473,413, filed on May 27, 2003.

(51) Int. Cl. G06F 7/00

(52) U.S. Cl. 708/200

(57) ABSTRACT

Various applications are presented of a vector field method of computing one or more eigenvalues and eigenvectors of a symmetric matrix. The vector field method computes an eigenvector by computing a discrete approximation to the integral curve of a special tangent vector field on the unit sphere. The optimization problems embedded in each iteration of the vector field algorithms admit closed-form solutions making the vector field approach relatively efficient. Among the several vector fields discussed is a family of vector fields called the recursive vector fields. Numerical results are presented that suggest that in some embodiments the recursive vector field method yields implementations that are faster than those based on the QR method. Further, the vector field method preserves, and hence can fully exploit the sparseness on the given matrix to speed up computation even further. Preprocessing that contracts the spectral radius of the given matrix further accelerates the systems.

### REFERENCE TO RELATED APPLICATION

This application claims priority to U.S. Provisional Application No. 60/473,413, filed May 27, 2003 (“The Provisional” herein).

### COMPUTER PROGRAM LISTING APPENDIX

A computer program listing appendix filed with this application on a single CD-ROM (submitted in duplicate) is hereby incorporated by reference as if fully set forth herein.

### FIELD PF THE INVENTION

The present invention relates to computationally efficient systems for estimating eigenvectors of square matrices. More specifically, the present invention relates to iterative processing of data structures that represent a square matrix corresponding to a mechanical, electrical, or computational system to obtain one or more data structures that each represent an eigenvector of the matrix and a corresponding eigenvalue.

### BACKGROUND

If A is a matrix, then a vector x is called an eigenvector of A, and a scalar λ is an eigenvalue of A corresponding to x, if Ax=λx.

The determination of eigenvalues and eigenvectors of given matrices has a wide variety of practical applications including, for example, stability and perturbation analysis, information retrieval, and image restoration. For symmetric matrices, it is known to use a divide-and-conquer approach to reduce the dimension of the relevant matrix to a manageable size, then apply the QR method to solve the subproblems when the divided matrix falls below a certain threshold size. For extremely large symmetric matrices, the Lanczos algorithm, Jacobi algorithm, or bisection method are used. Despite these alternatives, in several situations improved execution speed is still desirable.

The matrices that characterize many systems are very large (e.g., 3.7 billion entries square in the periodic ranking computation by Google) and very sparse (that is, they have very few nonzero entries; most of the entries are zero). If the matrix is sparse, one can speed up computations on the matrix (such as matrix multiplication) by focusing only on the small subset of nonzero entries. Such sparse-matrix techniques are very effective and very important if one is to handle large matrices efficiently. The existing methods identified above do not exploit sparseness in the matrices on which they operate because the methods themselves change the given matrix during their computations. Thus, even if one were to start with a sparse matrix, after just one step one could end up with a highly non-sparse matrix. There is thus a need for a method and apparatus that maintain the sparseness of the input matrix throughout processing, and is ideally suited to exploit that sparseness.

There is thus a need for further contributions and improvements to the technology of eigenvector and eigenvalue estimation.

### SUMMARY

It is an object of the present invention to apply a vector field method in a system and method for estimating the eigenvector of a matrix A and a corresponding eigenvalue. In some embodiments, the present invention improves iterative estimation of eigenvectors (and their corresponding eigenvalues) by applying a vector field V to the prior estimate. That is, the system iteratively determines xₖ₊₁ for k=0, 1, . . . (m−1) by finding an α* that yields an optimal solution of

$${max}_{α} {g}_{k} ( α ) := \frac{{( {x}_{k} + α V ( {x}_{k} ) )}^{T} A ( {x}_{k} + α V ( {x}_{k} ) )}{{‖ {x}_{k} + α V ( {x}_{k} ) ‖}^{2}} , then setting {x}_{k + 1} ← \frac{{x}_{k} + {α}^{*} V ( {x}_{k} )}{‖ {x}_{k} + {α}^{*} V ( {x}_{k} ) ‖} .$$

In other embodiments, a vector field method is applied to a matrix that characterizes web page interrelationships to efficiently compute an importance ranking for each web page in a set.

In yet other embodiments, matrix A is the Hessian matrix for a design of an engineered physical system. A vector field method is applied to determine the eigenvalues of A, and therefore the stability of the design.

In still other embodiments, a system provides a subroutine for efficiently calculating eigenvectors and eigenvalues of a given matrix. In those embodiments, a processor is in communication with a computer-readable medium encoded with programming instructions executable by the processor to apply a vector field method to efficiently determine one or more eigenvectors and/or eigenvalues, and to output the result.

### BRIEF DESCRIPTION OF THE DRAWINGS

FIG. 1 illustrates a sphere, tangent plane, and vector field for an embodiment of the invention where n=3.

FIG. 2 is a block diagram of a system for determining eigenvectors and/or eigenvalues according to one embodiment of the present invention.

FIG. 3 is a flowchart of a method for determining eigenvectors and/or eigenvalues according to another embodiment of the present invention.

FIG. 4 is a block diagram of a system that operates as a utility to determining eigenvectors and/or eigenvalues according to yet another embodiment of the present invention.

### DESCRIPTION

For the purpose of promoting an understanding of the principles of the present invention, reference will now be made to the embodiment illustrated in the drawings and specific language will be used to describe it. It will, nevertheless, be understood that no limitation of the scope of the invention is thereby intended; any alterations and further modifications of the described or illustrated embodiments, and any further applications of the principles of the invention as illustrated therein are contemplated as would normally occur to one skilled in the art to which the invention relates.

Generally, given a matrix A, such as the Hessian matrix in a structural stability analysis, or a Markov transition matrix characterizing the interlinking of hypertext pages, one embodiment of the present invention estimates eigenvalues and corresponding eigenvectors of A, which indicate stability or instability of the structure or a relative importance ranking of the pages, respectively. As discussed in further detail herein, consecutive estimates are computed using the projection of a correction vector that is calculated as a function of one or more particular vector fields. The eigenvectors are computed as a discrete approximation to the integral curve of a special tangent vector field on the unit sphere.

It is well known that computation of the largest eigenvalue of real symmetric matrix A reduces, by Rayleigh-Ritz Theorem, to the following quadratic program
λₘₐₓ=max{x^{T}Ax|x^{T}x=1} (2)
The eigenvalues of A can be computed by solving n such quadratic programs, reducing the dimension of the problem after the computation of each eigenvalue. Such an approach, like the divide-and-conquer methods, yields the eigenvectors as well as the eigenvalues of A. Thus the core problem is to compute a solution of the quadratic programming problem (2).

The feasible region of the problem (2) is the unit sphere. The tangent space at the point x ∈ Sⁿ⁻¹, denoted Tₓ is isomorphic to [symbol] ⁿ⁻¹. A tangent vector field V is an assignment of a vector V(x) ∈ Tₓ, to each point x ∈ Sⁿ⁻¹. We call a tangent vector field V an A-vector field, when V(x)=0 if and only if x is an eigenvector of A. The integral curves of an A-vector field end at its critical points, which correspond to eigenvectors of the given matrix A. Therefore, one could compute the eigenvectors of A, by integrating an A-vector field. Such an approach to eigen-computation is called the vector field method herein.

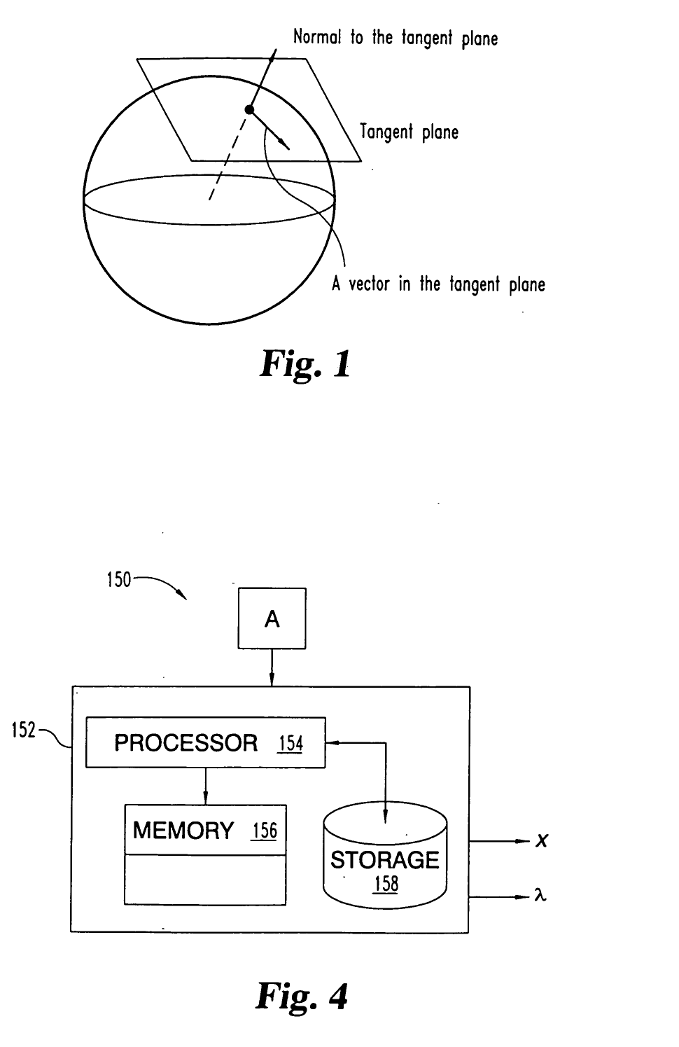

FIG. 1 illustrates the notion of a tangent vector field for n=3. An integral curve of the vector field is a curve 94 :R→Sⁿ⁻¹, with the property that

$$\frac{ⅆ σ ( t )}{ⅆ t} = V ( σ ( t ) ) .$$

A straightforward example of an A-vector field is the vector field V_{R}, derived as the projected gradient of the Rayleigh quotient ρ_{A}(x). For x ∈ Sⁿ⁻¹,
ρ_{A}(x)=x^{T}Ax; ∇ρ_{A}(x)=2Ax; V_{R}(x):=Πₓ(∇ρ_{A}(x))=2(I−xx^{T})Ax=2(Ax−ρ_{A}(x)x)
where Πₓ is the projection of a vector onto Tₓ. V_{R} is an A-vector field since
V_{R}(x)=0Ax=ρ_{A}(x)x,
which implies that x is an eigenvector of A, with eigenvalue ρ_{A}(x). Conversely, if x ∈ Sⁿ⁻¹ is an eigenvector of A corresponding to the eigenvalue λ, then ρ_{A}(x)=λ, which implies that V(x)=0.

We have considerable latitude in designing A-vector fields for a given real symmetric matrix A. In the following sections we focus on a family of vector fields called recursive vector fields. Research indicates that certain members of the above family are quite competitive in practice, and exhibit prospects of outperforming the algorithms based on the QR method.

### Computational Comparison of the Vector Field Method and the QR Method

The Vector Field Approach

Given a z ∈ Sⁿ⁻¹, the tangent plane at z, T_{z}, is a translate of the subspace z^{T}x=0. The collection of tangent spaces TSⁿ={T_{z}|z ∈ Sⁿ⁻¹} is called the tangent bundle of Sⁿ⁻¹. A tangent vector field, V is a map V:Sⁿ⁻¹→TSⁿ with the restriction that V(x) ∈ Tₓ. To generally describe one embodiment of the vector field method, given a tangent A-vector field V(x) defined on Sⁿ⁻¹, an eigenvector of A is computed as follows:
Input: A real symmetric matrix A and an A-vector field V(x):Sⁿ⁻¹→TSⁿ,
Output: An eigenvector of A
Step 1: Choose a random x₀ ∈ Sⁿ⁻¹. Set k←0.
Step 2: If xₖ is an eigenvector of A, output xₖ and stop. Else, solve

$${max}_{α} {g}_{k} ( α ) := \frac{{( {x}_{k} + α V ( {x}_{k} ) )}^{T} A ( {x}_{k} + α V ( {x}_{k} ) )}{{‖ {x}_{k} + α V ( {x}_{k} ) ‖}^{2}} . \qquad ( 3 )$$

Let α* be the optimal solution of (3).
Step 3:

$$Set {x}_{k + 1} ← \frac{{x}_{k} + {α}^{*} V ( {x}_{k} )}{‖ {x}_{k} + {α}^{*} V ( {x}_{k} ) ‖} \cdot k ← k + 1. Go to Step 2.$$
End.

In the following discussion we focus mainly on enhancements of the method outlined above, in which we optimize, in Step 2, over multiple vector fields, instead of a single vector field such as V(xₖ) as shown above. Nonetheless, Step 2, or a variant of it, is the key computation in all the vector field algorithms. Hence, we start the discussion of the vector field approach with the following Lemma, which gives the characterization of the maxima of the Rayleigh quotient over vector fields.

Lemma 1. Let A be an n×n real symmetric matrix. Let y, δ ∈ z,900 ⁿ be two linearly independent vectors. Define

$$z ( γ ) := \frac{y + γ δ}{‖ y + γδ ‖} , {ρ ( γ )}^{T} Az ( γ ) ,$$

ã:=δ^{T}Aδ, \tilde{b}:=δ^{T}Ay, \tilde{c}:=y^{T}Ay, \tilde{p}:=∥δ∥², \tilde{q}:=δ^{T}y, \tilde{s}:=∥y∥²,
Γ:=\tilde{bp}−\tilde{aq}, Ω:=\tilde{cp}−\tilde{as}, Θ:=\tilde{cq}−\tilde{bs}, Δ:=Ω²−4ΓΘ.
Then the following is a complete characterization of the maxima of the function ρ(γ).

Case 1: Γ=0.
1. If Ω=0 then ρ(γ) is a constant function.
2. If Ω<0 then ρ(γ) has a maximum at

$${γ}_{0} = - \frac{Θ}{Ω} .$$
3. If Ω>0 then ρ(γ) has a maximum at ±∞.

Case 2:Γ≠0.
1. In this case, Δ≧0.
2. If Δ=0 then
a. Ω≠0.
b. If Ω>0 then the function ρ(γ) has a maximum at

$${γ}_{0} = - \frac{Θ}{2 Γ} .$$
c. If Ω<0 then the function ρ(γ) has a maximum at ±∞.
If Δ>0 then the function ρ(γ) has a maximum at

$${γ}_{0} = \frac{- Ω - \sqrt{Δ}}{2 Γ} .$$

A corollary of Lemma 1 is the following Lemma 2:

Lemma 2. Let

$$g ( α ) := \frac{{( x + α d )}^{T} A ( x + α d )}{{‖ x + α d ‖}^{2}}$$

where x, d ∈ [symbol] ⁿ, ∥x∥=1, ∥d∥≠0, d^{T} Ax≠0, x^{T} d=0, and A:n×n matrix. Then g(α) attains its maximum value at

$${α}^{*} = \frac{f - ep}{2 bp}$$

where
α:=d^{T}Ad,
b:=d^{T}Ax,
c:=x^{T}Ax,
p:=∥d∥²,
e:=c−(a/p), and
f:=\sqrt{e²p²+4b²p}.

Lemma 1 shows that the 1-dimensional optimization problem (3) has a closed-form solution. The vector field algorithms that discussed below are modeled, more or less, along the generic vector field method described above, though they differ in their choice of the vector field V(x).

The algorithms we consider may be classified by the dimensionality of the subspace of Tₓ within which they search for the next iterate. Accordingly, the algorithms are named VFAn.m where n denotes the dimension of the subspace and m the identifier of the algorithm. For example, in VFA2.1 the vector field
V(xₖ;β,γ):=β(Axₖ−ρ^{(k)}xₖ)+γ(I−xₖxₖ^{T})V(xₖ₋₁)
where ρ^{(k)}=xₖ^{T} Axₖ is the Rayleigh quotient of xₖ ∈ Sⁿ⁻¹. To compute xₖ₊₁, therefore, we need to optimize over two parameters β and γ instead of one parameter as shown in (3). Thus VFA2.1 searches for the improving direction over a 2-dimensional subspace of Tₓ_{ₖ} and belongs to the VFA2.x family.

In the rest of the discussion it will be assumed that the matrix to be diagonalized is symmetric and positive definite. Assuming that a symmetric matrix A is positive definite does not lead to any loss of generality. One can use, for instance, the Gershgorin Disc Theorem [9] to compute a lower bound L on all the eigenvalues of A. Thereafter, replacing A by A′:=A−ηI where η<L, one obtains A′, which is symmetric positive definite. Given the eigenvalues of A′, the eigenvalues of A are easily computed.

The following Lemma is useful to show the convergence of the algorithms discussed herein.

Lemma 3. Let A by a symmetric positive definite matrix with eigenvalues λ₁≧λ₂≧ . . . ≧λₙ, and λ₁>λₙ. Let ρ^{(k)}:=xₖ^{T} Axₖ. (λ₁=λₙ is the trivial case A=λ₁I, which we disregard.) Consider the sequence {x_{i ∈ S}ⁿ⁻¹|i=1,2,3 . . . } generated by the recurrence equation

$${x}_{k + 1} = \frac{{x}_{k} + {β}_{k} {d}_{k}}{‖ {x}_{k} + {β}_{k} {d}_{k} ‖} ,$$

where

1. dₖ is any unit tangent vector in Tₓ_{ₖ}, dₖ^{T} Axₖ≠0, and

2. βₖ is chosen to maximize ρ^{(k+1)}:=xₖ₊₁^{T}Axₖ₊₁, as in Lemma 2.
Then

$${ρ}^{( k + 1 )} - {ρ}^{( k )} \geq \frac{{[ {d}_{k}^{T} {Ax}_{k} ]}^{2}}{( {λ}_{1} - {λ}_{n} ) + ‖ {d}_{k}^{T} {Ax}_{k} ‖} . \qquad ( 13 )$$

We can choose a dₖ ∈ Tₓ_{ₖ} such that dₖ^{T} Axₖ≠0, as long as Axₖ is not orthogonal to Tₓ_{ₖ}. On the other hand, if Axₖ is normal to Tₓ_{ₖ} then xₖ is an eigenvector of A. Hence we have the following corollary.

Corollary 1. Let A be an n×n real, symmetric, positive definite matrix, and p(x):=x^{T} Ax. Let X={x₁, x₂, . . . } ⊂Sⁿ⁻¹ be a sequence of points generated by the recurrence equation

$${x}_{k + 1} = \frac{{x}_{k} + {β}_{k} {d}_{k}}{‖ {x}_{k} + {β}_{k} {d}_{k} ‖} ; ‖ {d}_{k} ‖ \neq 0 ; {d}_{k}^{T} {Ax}_{k} \neq 0$$

$$where$$

$${d}_{k} = \frac{{Ax}_{k} - {ρ}^{( k )} {x}_{k}}{‖ {Ax}_{k} - {ρ}^{( k )} {x}_{k} ‖}$$

and βₖ is chosen to maximize ρ(xₖ₊₁), as in Lemma 2. Then the sequence X converges to an eigenvector of A.

Lemma 4. Let A be an n×n real, symmetric, positive definite matrix, and p(x):=x^{T}Ax. Let X={x₁, x₂, . . . } ⊂ Sⁿ⁻¹ not be a sequence of points. For each k=1, 2, . . . let

$${x}_{k + 1}^{′} := \frac{{x}_{k} + {β}_{k}^{′} {d}_{k}^{′}}{‖ {x}_{k} + {β}_{k}^{′} {d}_{k}^{′} ‖} where$$

$${d}_{k}^{′} = \frac{{Ax}_{k} - {ρ}^{( k )} {x}_{k}}{‖ {Ax}_{k} - {ρ}^{( k )} {x}_{k} ‖} , {ρ}^{( k )} := {x}_{k}^{T} {Ax}_{k} ,$$

and β′ₖ is chosen to maximize ρ(x′ₖ₊₁), as in Lemma 1. If
ρ(xₖ₊₁)≧ρ(x′ₖ₊₁), k=1, 2, 3, . . .
then the sequence X converges to an eigenvector of A. Further, given ε>0, the Ritz error term

$$‖ {Ax}_{k} - {ρ}^{( k )} {x}_{k} ‖ \leq ɛ$$

$$within \frac{( 2 {λ}_{1} - {λ}_{n} ) ( {λ}_{1} - {λ}_{n} )}{{ɛ}^{2}} steps .$$

With Lemma 4 as the background we investigate a few nontrivial vector field algorithms below. Before discussing the vector fields, we recall the notion of coordinate descent approximation to optimal solutions [15]. Consider the optimization problem:
max{f(x₁, . . . , xₘ)|(x₁, . . . , xₘ) ∈ [symbol] ^{m}}.
In a coordinate descent approach [15] one constructs an approximation to the optimal solution, by solving the following m scalar optimization problems, Sᵢ, i=1, . . . , m.

S₁:Set x₂= . . . xₘ=0 and solve the resulting problem
max hᵢ(xᵢ):=f(x₁, 0, . . . , 0)
to obtain an optimal solution x*₁.

Sᵢ, i=2, . . . , m: Let x*₁, . . . , x*ᵢ₋₁ be the optimal solutions obtained for S₁, . . . , Sᵢ₋₁. The optimal solution x*ᵢ of the 1-variable optimization problem Sᵢ is obtained by solving the problem
max hᵢ(xᵢ):=f(x*₁, . . . , x*ᵢ₋₁, xᵢ, 0, . . . , 0)
The approximation to the optimal solution, hereafter called the coordinate descent approximation, is then (x*₁, . . . , x*ₘ).

The family of vector fields that we investigate computationally is described by the following recurrence equation

$${x}_{k + 1} := \frac{{x}_{k} + {α}_{k}^{( 1 )} {δ}_{k}^{( 1 )} + … + {α}_{k}^{( r )} {δ}_{k}^{( r )}}{‖ {x}_{k} + {α}_{k}^{( 1 )} {δ}_{k}^{( 1 )} + … + {α}_{k}^{( r )} {δ}_{k}^{( r )} ‖} ; 1 \leq r \leq n \qquad ( 21 )$$

where δₖ⁽ⁱ⁾ ∈ T_{z}_{ₖ}, for i=1, . . . , r. Determining the optimal values of the r variables αₖ⁽¹⁾, . . . , αₖ^{(r)} involves solving the optimization problem

$${max}_{{α}_{k}^{( 1 )} , … , {α}_{k}^{( r )}} f ( {α}_{k}^{( 1 )} , … , {α}_{k}^{( r )} ) := {x}_{k + 1}^{T} {Ax}_{k + 1} . \qquad ( 22 )$$

Although (22) is a quadratic optimization problem, for which a number of algorithms are known, in the interest of overall computational speed, we do not solve the problem to optimality. Instead we resort to a fast computation of an approximation to the optimal solution using a coordinate descent approach. An approximation to the optimal solution of (22) is computed as follows. \tilde{α}ₖ⁽¹⁾ is the optimal solution of
S₁:max h₁(x):=f(x, 0, . . . , 0)
For i=2, . . . , r, \tilde{α}ₖ⁽ⁱ⁾ is the optimal solution of
Sᵢ:max hᵢ(x):=f(\tilde{α}ₖ⁽¹⁾, . . . , \tilde{α}ₖ⁽ⁱ⁻¹⁾, x, 0, . . . , 0)
Lemma 1 gives the closed-form solutions for the subproblems S₁, . . . , Sᵣ. The approximation to the optimal solution of (22) is then taken to be (\tilde{α}ₖ⁽ⁱ⁾, . . . ,\tilde{α}ₖ^{(r)}).

Lemma 5. Let A be an n×n real, symmetric, positive definite matrix. Let X={x₁, x₂, . . . , sₙ} ⊂ Sⁿ⁻¹ be a sequence of vectors generated by the recurrence equation

$${x}_{k + 1} := \frac{{x}_{k} + {\tilde{α}}_{k}^{( 1 )} {δ}_{k}^{( 1 )} + … + {\tilde{α}}_{k}^{( r )} {δ}_{k}^{( r )}}{‖ {x}_{k} + {\tilde{α}}_{k}^{( 1 )} {δ}_{k}^{( 1 )} + … + {\tilde{α}}_{k}^{( r )} {δ}_{k}^{( r )} ‖} ; 1 \leq r \leq n where$$

$${δ}_{k}^{( 1 )} = \frac{{Ax}_{k} - {ρ}^{( k )} {x}_{k}}{‖ {Ax}_{k} - {ρ}^{( k )} {x}_{k} ‖}$$

and (\tilde{α}ₖ⁽¹⁾), . . . , \tilde{α}ₖ^{(r)}) is a coordinate descent approximation of the optimal solution of the problem

$${max}_{{α}_{k}^{( 1 )} , … , {α}_{k}^{( r )}} f ( {α}_{k}^{( 1 )} , … , {α}_{k}^{( r )} ) := {x}_{k + 1}^{T} {Ax}_{k + 1}$$

Then the sequence X converges to an eigenvector of A.
2.2 Interpretation of the Vector Field Algorithms

Observe that at x ∈ Sⁿ⁻¹, the gradient of the Rayleigh quotient

$$R ( x ) = \frac{{x}^{T} Ax}{{x}^{T} x} ,$$

is
∇R(x)=2(Ax−(x^{T} Ax)x)=2(Ax−ρ(x)x),
and its projection onto Tₓ is
Π(∇R(x))=(I=xx^{T})(2Ax−2ρ(x)x)=2(Ax−ρ(x)x).
Hence the locally optimal search direction in Tₓ is
\hat{d}:=Ax−ρ(x)x.
While \hat{d} is locally optimal it is not necessarily the best search direction in Tₓ. Define φ:Tₓ→R,

$$φ ( d ) = {max}_{α ∈ R} \{ \frac{{( x + ad )}^{T} A ( x + ad )}{{‖ x + ad ‖}^{2}} \}$$

Clearly, the best search direction d*, if one is looking for the eigenvector corresponding to the largest eigenvalue, is the solution of the optimization problem

$${max}_{d ∈ {T}_{x}} φ ( d ) = {max}_{{κ}_{1} , … , {κ}_{n - 1} ∈ R} φ ( {κ}_{1} {\hat{e}}_{1} + … + {κ}_{n - 1} {\hat{e}}_{n - 1} ) \qquad ( 24 )$$

where ê₁, . . . , êₙ₋₁ is a basis of Tₓ.

On the other hand, if one is looking for some eigenvector, not necessarily that corresponding to the largest eigenvalue, then define ψ:Tₓ→R as

$$\begin{matrix}ψ ( d ) := {min}_{β ∈ R} ‖ A ( x + β d ) - [ ρ ( x + β d ) ] ( x + β d ) ‖ \\ = {min}_{β ∈ R} [ {( x + β d )}^{T} {A}^{2} ( x + β d ) - {( {( x + β d )}^{T} A ( x + β d ) )}^{2} ] \\ = {min}_{β ∈ R} [ {b}_{4} {β}^{4} + {b}_{3} {β}^{3} + {b}_{2} {β}^{2} + {b}_{1} β + {b}_{0} ]\end{matrix} \qquad ( 23 )$$

where the coefficients bᵢ, 0≦i≦4 are easily inferred from the above equation. Given Cardano's solution of cubic equations, the problem (23) has a closed form solution as well; see Appendix A. In this case, the best direction d* is obtained by solving

$${min}_{d ∈ {T}_{x}} ψ ( d ) = {min}_{{k}_{1} , … , {k}_{n - 1} ∈ R} ψ ( {k}_{1} \hat{e} 1 + … + {k}_{n - 1} {\hat{e}}_{n - 1} )$$

Clearly, φ(d*)≧φ(\hat{d}) and in general d*≠\hat{d}. However, computing d* involves solving an (n−1)-variable optimization problem as against computing \hat{d}, which requires only two matrix-vector multiplications. However, although d* is much harder to compute than \hat{d}, as one would expect, it immediately yields the eigenvector of A.

Lemma 6 Let A be an n×n matrix and x ∈ Sⁿ⁻¹. Let ν be a unit eigenvector of A. Then there exists a d ∈ Tₓ, and an α≧0 (possibly α→∞) such that

$$v = \frac{x + α d}{‖ x + α d ‖} \qquad ( 25 )$$

Proof: ν and −ν represent the same eigenvector. For every vector y αSⁿ⁻¹, either y or −y can be written as in (25).

Lemma 6 shows that the d* computed in (24) is not merely the best search direction in Tₓ; it yields the eigenvector of A corresponding to the largest eigenvalue of A. Instead of using the naive search direction \hat{d}, the vector field algorithms we study attempt to construct, in each step, an approximation to d*. Observe that the recurrence equation (23) in Lemma 5 can be rewritten as

$$\begin{matrix}{x}_{k + 1} := \frac{{x}_{k} + {\tilde{α}}_{k}^{( 1 )} ( {δ}_{k}^{( 1 )} + {Δ }_{k} )}{‖ {x}_{k} + ( {\tilde{α}}_{k}^{( 1 )} + {Δ}_{k} ) ‖} ; & {Δ}_{k} := ( \frac{{\tilde{α}}_{k}^{( 2 )}}{{\tilde{α}}_{k}^{( 1 )}} ) {δ}_{k}^{( 2 )} + … + ( \frac{{\tilde{α}}_{k}^{( r )}}{{\tilde{α}}_{k}^{( 1 )}} ) {δ}_{k}^{( r )} \\ = \frac{{x}_{k} + {\tilde{α}}_{k}^{( 1 )} {d}_{k}}{‖ {x}_{k} + {\tilde{α}}_{k}^{( 1 )} {d}_{k} ‖} ; & {d}_{k} := {δ}_{k}^{( 1 )} + {Δ}_{k}\end{matrix} \qquad ( 26 )$$

Thus the recurrence equation computes, in each step, a correction Δₖ to the projected gradient direction δₖ⁽¹⁾. The αₖ⁽¹⁾ used in the recurrence equation is optimal for δₖ⁽¹⁾, but not necessarily optimal for δₖ⁽¹⁾+Δₖ. After computing the correction Δₖ, one could compute the optimal value of αₖ⁽¹⁾ for the corrected direction δₖ⁽¹⁾+Δₖ using Lemma 1.

The correction Δₖ to the projected gradient direction skews the search direction towards the optimal direction d* in the sense that the improvement in the Rayleigh quotient ρ(xₖ₊₁) achieved using the correction Δₖ is greater than that achieved without the correction. Specifically, using the above discussion and the terminology of Lemma 6,
φ(δₖ⁽¹⁾+Δₖ)≧f(\tilde{α}ₖ⁽¹⁾, . . . , \tilde{α}ₖ^{(r)})≧f(\tilde{α}ₖ⁽¹⁾, 0, . . . , 0)=φ(δₖ⁽¹⁾)
The vector field algorithms that we describe below differ, principally, in the corrections they compute to the projected gradient direction.

### 3. Description of the Vector Fields

Recall that the general recurrence equation for vector field algorithms is

$$\begin{matrix}{x}_{k + 1} := \frac{{x}_{k} + {α}_{k}^{( 1 )} {δ}_{k}^{( 1 )} + … + {α}_{k}^{( r )} {δ}_{k}^{( r )}}{‖ {x}_{k} + {α}_{k}^{( 1 )} {δ}_{k}^{( 1 )} + … + {α}_{k}^{( r )} {δ}_{k}^{( r )} ‖} ; & 1 \leq r \leq n\end{matrix} \qquad ( 27 )$$

Eigenvalue algorithms derived from the above recurrence equation with r=k constitute the family called the k-dimensional Vector Field Algorithms, denoted VFAk. We study three 1-dimensional vector field algorithms, called VFA1.1, VFA1.2 and VFA1.3, which are derived respectively from the steepest descent method, the DFP method and Newton 's method for nonlinear optimization. We also study four members of the VFA2 family derived from the conjugate gradient method and the DFP method (called VFA2.1, VFA2.2, VFA2.3 and VFA2.4) and a member of the VFA3 family derived from the conjugate gradient method (VFA3.1). The vector fields for the aforementioned algorithms for the problem

$$max f ( x ) := \frac{1}{2} ( \frac{{x}^{T} Ax}{{x}^{T} x} ) \qquad ( 28 )$$

are as follows. In the following discussion we have used the fact that ∥xₖ∥=1 and let ρ(x)=x^{T}Ax.

3.0.1 VFA1 Family

From the preceding discussion, algorithms in the VFA1 family, are fully specified given the search direction δₖ⁽¹⁾. The δₖ⁽¹⁾ for the three algorithms we study are as follows:

Steepest Ascent Vector Field (VFA1.1):

In this method, the search direction is the projected gradient of the Rayleigh quotient
δₖ⁽¹⁾:=Axₖ−ρ(xₖ)xₖ.

DFP Vector Field (VFA1.2):

Preliminary numerical results about this method appear in [7]. One of the very successful quasi-Newton algorithms is the DFP algorithm (Davidson, Fletcher and Powell) [16]. The search direction derived from the DFP method is

$$\begin{matrix}{δ}_{k}^{( 1 )} := - ( I - {x}_{k} {x}_{k}^{T} ) {H}_{k} ( {Ax}_{k} - ρ ( {x}_{k} ) {x}_{k} ) ; & & ρ ( {x}_{k} ) := {x}_{k}^{T} {Ax}_{k} ; \\ {H}_{k} := {H}_{k - 1} - \frac{{H}_{k - 1} {y}_{k - 1} {y}_{k - 1}^{T} {H}_{k - 1}}{{y}_{k - 1}^{T} {H}_{k - 1} {y}_{k - 1}} + \frac{{s}_{k - 1} {s}_{k - 1}^{T}}{{y}_{k - 1}^{T} {s}_{k - 1}} ; & & {s}_{k - 1} := {x}_{k} - {x}_{k - 1} ;\end{matrix} \qquad ( 29 )$$

yₖ₋₁:=Axₖ−ρ(xₖ)xₖ−Axₖ₋₁=ρ(xₖ₋₁)xₖ₋₁;
H₀:=I.

Newton Vector Field (VFA1.3):

Newton's method, like the DFP method, uses a quadratic approximation of the objective function [16]. Unlike the DFP method, however, the Hessian of the quadratic approximation in Newton's method actually coincides with the quadratic term in the Taylor expansion of the function. Accordingly, the search direction derived from the Newton's method is
δₖ⁽¹⁾:=−(I−xₖxₖ^{T})[H(xₖ)]⁻¹(Axₖ−ρ(xₖ)xₖ), (30)
where H(xₖ) is the Hessian of the f(x) defined in (28).

VFA2 Family

A VFA2 recurrence equation requires the specification of two vector fields δₖ⁽¹⁾ and δₖ⁽²⁾. In all of the four algorithms below we take
δₖ⁽¹⁾:=Axₖ−ρ(xₖ)xₖ (31)
As discussed in Subsection 2.2, we seek to compute corrections to the projected gradient direction δₖ⁽¹⁾ that skew the corrected direction towards the optimal search direction d*. We consider four such corrections below.

Recursive Vector Field (VFA2.1):

One of the most efficient search strategies in nonlinear optimization is to construct the search directions recursively. A well-studied example of such recursive construction is the conjugate gradient method in which the current search direction is constructed using the previous search direction using the conjugacy condition [16]. The following correction to the projected gradient is, likewise, defined recursively as
δₖ⁽²⁾:=(I−xₖxₖ^{T})δxₖ₋₁; where δxₖ₋₁:=xₖ−xₖ₋₁;
with δ₀⁽²⁾:=0. In keeping with the reputation of the recursive search methods, this vector field yields an eigenvalue algorithm whose performance, as the computations in Subsection 4 show, appears to be superior to that of the QR method.

Recursive conjugate vector field (VFA2.2):

Recall that the values of αₖ⁽¹⁾ and αₖ⁽²⁾ in a 2-dimensional vector field algorithm are determined through a coordinate descent approach. As shown in equation (26), one can rewrite the recurrence equation as

$${x}_{k + 1} := \frac{{x}_{k} + {\tilde{α}}_{k}^{( 1 )} ( {δ}_{k}^{( 1 )} + {Δ}_{k} )}{‖ {x}_{k} + {\tilde{α}}_{k}^{( 1 )} ( {δ}_{k}^{( 1 )} + {Δ}_{k} ) ‖} ; \qquad {Δ}_{k} := ( \frac{{\tilde{α}}_{k}^{( 2 )}}{{\tilde{α}}_{k}^{( 1 )}} ) δ {x}_{k - 1} .$$

While the value αₖ⁽¹⁾ was optimal for δₖ⁽¹⁾, it is not necessarily optimal for δₖ⁽¹⁾+Δₖ. An alternative to such coordinate descent optimization is to rename

$${β}_{k} := \frac{{\tilde{α}}_{k}^{( 2 )}}{{\tilde{α}}_{k}^{( 1 )}} ; \qquad {α}_{k} := {\tilde{α}}_{k}^{( 1 )} ,$$

and write the recurrence equation as

$$\begin{matrix}{x}_{k + 1} := \frac{{x}_{k} + {α}_{k}^{*} {D}_{k}}{‖ {x}_{k} + {α}_{k}^{*} {D}_{k} ‖} ; \\ {D}_{k} := {δ}_{k}^{( 1 )} + {β}_{k} ( I - {x}_{k} {x}_{k}^{T} ) δ {x}_{k - 1} . \\ := {δ}_{k}^{( 1 )} + {β}_{k} {δ}_{k}^{( 2 )} \end{matrix} \qquad ( 32 )$$

The βₖ in the correction term is computed by insisting that Dₖ be A-conjugate to the projection of δxₖ₋₁, i.e., (I−xₖxₖ^{T})δxₖ₋₁. Setting

$$\begin{matrix}{D}_{k}^{T} A ( I - {x}_{k} {x}_{k}^{T} ) δ {x}_{k - 1} = 0 , \\ ⇒ {( {δ}_{k}^{( 1 )} + {β}_{k} {δ}_{k}^{( 2 )} )}^{T} A {δ}_{k}^{( 2 )} = 0 , \\ ⇒ {β}_{k} = - \frac{{( {δ}_{k}^{( 1 )} )}^{T} A {δ}_{k}^{( 2 )}}{{( {δ}_{k}^{( 2 )} )}^{T} A {δ}_{k}^{( 2 )}}\end{matrix} \qquad ( 33 )$$

With the value of βₖ determined, as in (33), one can obtain the optimal value α*ₖ, using Lemma 1.

DFP Correction Vector Field (VFA2.3):

Instead of a recursive correction to the projected gradient, in this variant of VFA2.1, the correction term is derived from the DFP direction. Specifically,
δₖ⁽²⁾:=−(I−xₖxₖ^{T})Hₖ(Axₖ−ρ(xₖ)xₖ)xₖ); ρ(xₖ):=xₖ^{T} Axₖ;

$$\begin{matrix}{H}_{k} := {H}_{k - 1} - \frac{{H}_{k - 1} {y}_{k - 1} {y}_{k - 1}^{T} {H}_{k - 1}}{{y}_{k - 1}^{T} {H}_{k - 1} {y}_{k - 1}} + \frac{{s}_{k - 1} {s}_{k - 1}^{T}}{{y}_{k - 1}^{T} {s}_{k - 1}} ; & & {s}_{k - 1} := {x}_{k} - {x}_{k - 1} ;\end{matrix} \qquad ( 34 )$$

yₖ₋₁:=Axₖ−ρ(xₖ)xₖ−Axₖ₋₁+ρ(xₖ₋₁)xₖ₋₁.
H₀:=I

DFP Conjugate Vector Field (VFA2.4)

This vector field is a variant of the recursive conjugate vector field in which, in the definition of Dₖ in equation (32), instead of δxₖ₋₁, one uses the δₖ⁽²⁾ defined in equation (34).

The algorithms VFA2.3 and VFA2.4, are variants of VFA2.1 and VFA2.2 respectively, in which the recursively defined term δxₖ₋₁ has been replaced by the DFP direction. The motivation for studying the DFP corrections—in VFA2.3 and VFA2.4—in place of the recursively defined terms stemmed from the promising performance of the DFP search direction in VFA1.2.

3.0.3 VFA3 Family

The recursive vector fields in VFA2.1 and FVA2.2 performed very competitively in numerical experiments, as shown by the results presented in the next section. Therefore, it appeared promising to extend 2-dimensional vector fields to k-dimensional vector fields with (k−1)-level recursion. We construct such a 3-dimensional vector field as follows:
δₖ⁽¹⁾:=Axₖ−ρ(xₖ)xₖ
δₖ⁽²⁾:=(I−xₖxₖ^{T})δxₖ₋₁ where δxₖ₋₁:=xₖ−xₖ₋₁
δₖ⁽³⁾:=(I−xₖxₖ^{T})δxₖ₋₂ where δxₖ₋₂:=xₖ₋₁−xₖ₋₂
where \tilde{α}ᵢ^{(j)} denotes the optimal value of αᵢ^{(j)} computed using the coordinate descent approach.

The convergence of VFA1.1, VFA2.1, VFA2.3 and VFA3 are guaranteed by Lemma 4. In Subsection 4 we present the results of numerical experiments with the above vector fields. The numerical results are discussed in Section 5.

### 4 Numerical Results

We present below a numerical comparison of the performance of the vector field algorithms and the QR method. The n×n matrices for the experiments were generated randomly using the RAND function in MATLAB. The random matrices were symmetrized to obtain the symmetric matrices for our experiments. The matrix size parameter n was varied from 5 to 50 in increments of 5 and from 50 to 100 in increments of 10. At each n, one hundred random symmetric matrices were generated as described above; each random symmetric matrix was diagonalized using each of the following ten algorithms: QR, the power method and the eight vector field algorithms described in the previous subsection.

All of the algorithms were implemented on MATLAB 6.1 and run on Dell Optiplex GX 260 workstations (1.86 GHz, 256 MB and 512 KB cache). The QR algorithm invoked the built-in QR-decomposition routine of MATLAB in each iteration.

Results of comparative testing appear in Tables 1-4. The execution times themselves are less significant than the relative times shown for the various algorithms given the same input matrices and iteration counts. It is noteworthy that only the QR technique used code that was professionally written at the compiled-language level, while the other techniques were implemented using MATLAB scripts. The relative performance of the VFA techniques, therefore, is expected to be even better given an investment of analogous amounts of time and effort in optimization of the respective implementations.

TABLE 1
Average number of iterations over 100 experiments

| n | QR | Power | VFA1.1 | VFA1.2 | VFA1.3 | VFA2.1 | VFA2.3 | VFA2.2 | VFA2.4 | VFA3.1 |
|---|---|---|---|---|---|---|---|---|---|---|
| 5 | 186.63 | 310.76 | 19.89 | 13.95 | 19.89 | 17.42 | 15.09 | 12.08 | 17.34 | 11.2 |
| 10 | 365.29 | 1076.73 | 122.99 | 62.57 | 122.99 | 94.8 | 65.51 | 55.2 | 67.89 | 47.29 |
| 15 | 565.52 | 2101.17 | 310.61 | 138.36 | 310.61 | 206.12 | 146.74 | 120.63 | 148.12 | 102.15 |
| 20 | 688.04 | 3218.28 | 575.48 | 239.89 | 575.48 | 332.7 | 256.61 | 204.55 | 255.94 | 173.78 |
| 25 | 889.3 | 4587.15 | 940.91 | 360.92 | 940.91 | 477.88 | 394.98 | 308.62 | 384.1 | 258.83 |
| 30 | 1017.28 | 5851.38 | 1316.53 | 504.59 | 1316.53 | 632.31 | 553.61 | 422.35 | 538.95 | 354.54 |
| 35 | 1044.12 | 7333.27 | 1800.86 | 665.4 | 1800.86 | 804.11 | 736.19 | 554.29 | 705.78 | 462.32 |
| 40 | 1192.09 | 8838.34 | 2353.73 | 843.3 | 2353.73 | 1012.02 | 946 | 689.94 | 894.74 | 578.88 |
| 45 | 1286.8 | 10615.5 | 2997.14 | 1033.4 | 2997.14 | 1301.52 | 1171.3 | 849.87 | 1101.74 | 707.17 |
| 50 | 1480.31 | 12263 | 3693.72 | 1235.9 | 3693.72 | 1600.31 | 1435.63 | 1025.27 | 1332.09 | 841.5 |
| 60 | 1589.08 | 15662.4 | 5164.77 | 1677.19 | 5164.77 | 2230.18 | 1973.48 | 1368.82 | 1802.77 | 1128.21 |
| 70 | 1783.69 | 19576 | 7021.18 | 2173.41 | 7021.18 | 3087.58 | 2619.93 | 1813.86 | 2342.2 | 1456.07 |
| 80 | 2122.04 | 23584.3 | 9118.53 | 2706.42 | 9118.53 | 4038.16 | 3306.68 | 2279.64 | 2909.17 | 1814.91 |
| 90 | 2309.91 | 27724.9 | 11448.2 | 3275.81 | 11448.2 | 5173.8 | 4084.82 | 2761.3 | 3540.09 | 2193.1 |
| 100 | 2651.85 | 31827.7 | 13869.1 | 3885.34 | 13869.1 | 6351.15 | 4905.54 | 3282.36 | 4196.92 | 2601.54 |

TABLE 2
Standard Deviation of number of iterations over 100 experiments

| n | QR | Power | VFA1.1 | VFA1.2 | VFA1.3 | VFA2.1 | VFA2.3 | VFA2.2 | VFA2.4 | VFA3.1 |
|---|---|---|---|---|---|---|---|---|---|---|
| 5 | 98.6098 | 99.9243 | 8.7084 | 3.58553 | 8.7084 | 6.54924 | 2.36598 | 2.46871 | 2.50744 | 1.63917 |
| 10 | 153.673 | 188.435 | 24.7127 | 4.81633 | 24.7127 | 12.9006 | 4.84611 | 6.07362 | 5.0889 | 3.44449 |
| 15 | 287.436 | 332.216 | 56.347 | 6.75774 | 56.347 | 20.7444 | 11.2651 | 11.1116 | 7.62145 | 6.14862 |
| 20 | 328.244 | 430.205 | 101.378 | 9.54087 | 101.378 | 33.7036 | 16.4082 | 16.9404 | 13.0375 | 9.5733 |
| 25 | 393.007 | 527.153 | 142.112 | 12.0459 | 142.112 | 62.2937 | 20.4188 | 26.4853 | 17.0309 | 11.6411 |
| 30 | 539.222 | 610.546 | 179.734 | 18.8734 | 179.734 | 51.7001 | 26.4082 | 29.5034 | 22.9 | 16.3129 |
| 35 | 421.16 | 620.068 | 183.112 | 22.3295 | 183.112 | 64.4749 | 33.5763 | 37.2082 | 28.037 | 19.8829 |
| 40 | 451.367 | 815.648 | 248.128 | 26.196 | 248.128 | 95.9986 | 39.0247 | 43.044 | 31.338 | 22.4699 |
| 45 | 415.85 | 740.82 | 262.66 | 31.3008 | 262.66 | 150.912 | 42.848 | 52.6559 | 37.461 | 23.9941 |
| 50 | 520.077 | 776.907 | 319.804 | 39.3927 | 319.804 | 200.655 | 61.284 | 66.7977 | 54.7418 | 30.9501 |
| 60 | 523.686 | 1047.4 | 438.433 | 44.542 | 438.433 | 253.326 | 71.5761 | 74.7507 | 61.3448 | 34.7416 |
| 70 | 603.168 | 1155.48 | 506.816 | 51.3568 | 506.816 | 327.186 | 100.507 | 100.314 | 78.8654 | 38.7484 |
| 80 | 825.848 | 1345.22 | 655.905 | 62.0754 | 655.905 | 447.664 | 89.1488 | 126.563 | 75.2457 | 49.4501 |
| 90 | 817.6 | 1566.47 | 758.945 | 67.9222 | 758.945 | 506.836 | 122.095 | 152.474 | 81.6904 | 55.0162 |
| 100 | 1143.92 | 1415.99 | 892.47 | 80.6751 | 892.47 | 532.905 | 135.866 | 186.389 | 98.9338 | 67.2061 |

TABLE 3
Average CPU Time among 100 experiments

| n | QR | Power | VFA1.1 | VFA1.2 | VFA1.3 | VFA2.1 | VFA2.3 | VFA2.2 | VFA2.4 | VFA3.1 |
|---|---|---|---|---|---|---|---|---|---|---|
| 5 | 0.01689 | 0.02448 | 0.00596 | 0.00752 | 0.00595 | 0.00641 | 0.00733 | 0.00542 | 0.00889 | 0.00596 |
| 10 | 0.07234 | 0.10029 | 0.03143 | 0.03144 | 0.04417 | 0.03019 | 0.03722 | 0.02587 | 0.0415 | 0.02832 |
| 15 | 0.13067 | 0.19847 | 0.0834 | 0.07924 | 0.11471 | 0.07525 | 0.09193 | 0.0681 | 0.09512 | 0.07254 |
| 20 | 0.221 | 0.33987 | 0.17405 | 0.15952 | 0.24425 | 0.14637 | 0.18408 | 0.13546 | 0.19005 | 0.14444 |
| 25 | 0.39179 | 0.53331 | 0.31559 | 0.28357 | 0.45264 | 0.25395 | 0.3281 | 0.24145 | 0.33174 | 0.25697 |
| 30 | 0.61387 | 0.79321 | 0.5288 | 0.48052 | 0.77325 | 0.42111 | 0.55188 | 0.40551 | 0.55732 | 0.42813 |
| 35 | 1.12448 | 1.50188 | 1.12616 | 1.00636 | 1.62116 | 0.88556 | 1.16508 | 0.84932 | 1.13816 | 0.89736 |
| 40 | 1.21845 | 1.45434 | 1.16718 | 1.03627 | 1.69499 | 0.88982 | 1.19892 | 0.86552 | 1.1615 | 0.90662 |
| 45 | 1.68369 | 1.95913 | 1.69448 | 1.47319 | 2.44858 | 1.27033 | 1.71546 | 1.22983 | 1.64107 | 1.28101 |
| 50 | 2.54862 | 2.57862 | 2.38051 | 2.04147 | 3.43989 | 1.75671 | 2.40268 | 1.69857 | 2.26304 | 1.76055 |
| 60 | 4.41523 | 4.1467 | 4.28844 | 3.58204 | 6.15951 | 3.05219 | 4.27003 | 2.93904 | 3.92595 | 3.03447 |
| 70 | 7.57512 | 6.37361 | 7.27295 | 5.85659 | 10.3125 | 4.9622 | 7.11778 | 4.75816 | 6.37887 | 4.87876 |
| 80 | 15.7935 | 11.1633 | 14.031 | 10.8384 | 19.6125 | 9.0837 | 13.3702 | 8.67451 | 11.6538 | 8.79612 |
| 90 | 31.605 | 21.2064 | 29.0244 | 21.7489 | 40.2745 | 17.8326 | 27.0905 | 16.921 | 23.3512 | 17.4862 |
| 100 | 55.8218 | 34.4245 | 49.6193 | 36.2457 | 68.1197 | 29.8083 | 46.6496 | 28.4168 | 39.3079 | 28.6119 |

TABLE 4
Standard Deviation of CPU Time over 100 experiments

| n | QR | Power | VFA1.1 | VFA1.2 | VFA1.3 | VFA2.1 | VFA2.3 | VFA2.2 | VFA2.4 | VFA3.1 |
|---|---|---|---|---|---|---|---|---|---|---|
| 5 | 0.0095 | 0.008 | 0.0076 | 0.0078 | 0.0076 | 0.0077 | 0.0078 | 0.0074 | 0.0077 | 0.0076 |
| 10 | 0.0481 | 0.0243 | 0.0071 | 0.0047 | 0.0117 | 0.0060 | 0.0083 | 0.0077 | 0.0100 | 0.0095 |
| 15 | 0.0696 | 0.0238 | 0.0087 | 0.0074 | 0.0194 | 0.0089 | 0.0080 | 0.0078 | 0.0076 | 0.0081 |
| 20 | 0.1085 | 0.0358 | 0.0164 | 0.0068 | 0.0327 | 0.0088 | 0.0110 | 0.0080 | 0.0085 | 0.0075 |
| 25 | 0.1812 | 0.0433 | 0.0250 | 0.0089 | 0.0459 | 0.0136 | 0.0136 | 0.0107 | 0.0127 | 0.0104 |
| 30 | 0.3713 | 0.2340 | 0.1674 | 0.1445 | 0.2593 | 0.1235 | 0.1582 | 0.1252 | 0.1799 | 0.1353 |
| 35 | 0.4400 | 0.1595 | 0.0938 | 0.0969 | 0.1620 | 0.0904 | 0.0933 | 0.0772 | 0.0932 | 0.0824 |
| 40 | 0.5533 | 0.0708 | 0.0538 | 0.0170 | 0.1165 | 0.0196 | 0.0246 | 0.0162 | 0.0219 | 0.0133 |
| 45 | 0.6557 | 0.0672 | 0.0705 | 0.0202 | 0.1766 | 0.0294 | 0.0303 | 0.0184 | 0.0276 | 0.0143 |
| 50 | 1.0657 | 0.0818 | 0.0992 | 0.0260 | 0.2391 | 0.0417 | 0.0545 | 0.0201 | 0.0401 | 0.0143 |
| 60 | 1.6958 | 0.1157 | 0.1704 | 0.0391 | 0.4356 | 0.0608 | 0.0766 | 0.0239 | 0.059 | 0.0199 |
| 70 | 2.7987 | 0.1483 | 0.2766 | 0.0567 | 0.6147 | 0.0898 | 0.151 | 0.0389 | 0.0951 | 0.0259 |
| 80 | 9.8865 | 3.8526 | 4.9382 | 3.7252 | 7.1854 | 3.1635 | 4.6006 | 2.9641 | 3.9446 | 2.9784 |
| 90 | 17.4022 | 8.1403 | 11.3462 | 8.4762 | 15.9536 | 6.8450 | 10.3986 | 6.4958 | 9.0368 | 6.9933 |
| 100 | 27.0908 | 8.3678 | 11.6468 | 8.4085 | 16.0702 | 7.0500 | 10.9694 | 6.7912 | 9.2452 | 6.6890 |

### Additional Discussion

The execution times reflected in Tables 1-4 reflect that not all tangent vector fields yield superior performance to the QR method. The recursive vector fields discussed above (VFA1.1, VFA2.1, VFA2.2, and VFA3.1) compare favorably with the QR method in this experiment. It is further noted that the efficiency of the recursive vector fields in terms of mean CPU time does not appear to increase monotonically with increasing recursion level, appearing to be at level one recursion.

Another point pertains to the bound on the improvement of the Rayleigh quotient in equation (13). In particular, as dₖ^{T} Axₖ→0, with ∥dₖ∥=∥xₖ∥=1, i.e., as Axₖ becomes nearly orthogonal to Tₓ_{ₖ},

$${ρ}^{( k + 1 )} - {ρ}^{( k )} \geq \frac{{[ {d}_{k}^{T} {Ax}_{k} ]}^{2}}{( {λ}_{1} - {λ}_{n} )} .$$

Thus, the spectral radius of A, γ₁−γₙ, appears to become a large damping factor that slows down convergence. It appears, therefore, that preprocessing A to ensure that it is not only positive definite, but also that it has a small spectral radius could improve the speed of convergence of vector field algorithms considerably.

One of the strengths of the vector field algorithms is that the errors arising from floating point calculations do not accumulate as the algorithm progresses, since we rescale the vectors, in each step, to confine the sequence X={x₁, x₂, . . . } to Sⁿ⁻¹.

Another potentially significant advantage that vector field method has over the QR method pertains to sparse matrices. The sparseness of A is not preserved in the QR method, whereas in the vector field methods, the matrix A is used only to compute the quadratic forms
ã:=δ^{T}Aδ, \tilde{b}:=δ^{T} Ay, \tilde{c}:=y^{T} Ay
in each iteration. Since A will be used in its original form, the above computations would be very fast, when A is sparse, and hence vector field methods could yield additional improvement over the QR method for sparse matrices. If A is not sparse however, one could pay a preprocessing cost to convert A to tridiagonal form and again make the above calculations very efficient. Thus, whether or not A is sparse, the vector field algorithms, implemented properly, would need to spend only O(n) effort per iteration.

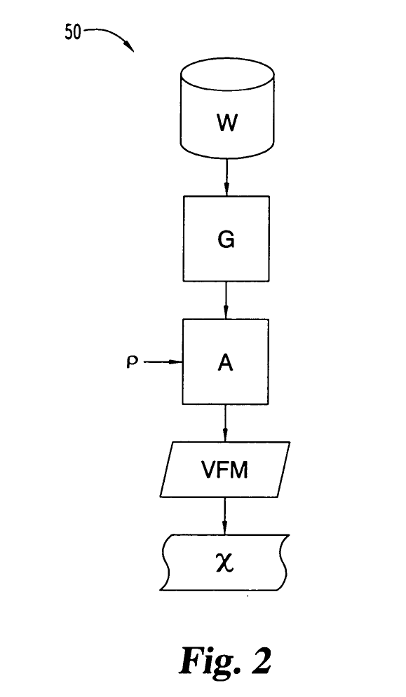

These numerical techniques are applied to a variety of technical problems in a variety of systems. One exemplary system, illustrated as system 50 in FIG. 2, begins with an ordered set W of n web pages that can be reached by following a chain of hyperlinks. An n×n matrix G is created, where each gᵢⱼ=1 if there is a hyperlink from page i to page j, and otherwise gᵢⱼ=0. Then the system calculates the row sums rₖ=Σⱼ gₖⱼ and cₖ=Σᵢ g_{i,k} for each page k, which are the counts of incoming and outgoing links, respectively, for that page k.

The system accesses a predetermined constant p, which is an arbitrarily determined, projected likelihood that a user would follow a link from a page, as opposed to jumping to a page to which there is no link from their current page. The system calculates

$$d = \frac{1 - p}{n} ,$$

then fills matrix A such that each

$${a}_{i , j} = \frac{{pg}_{i , j}}{{c}_{j}} + d .$$

This matrix A is the transition probability matrix of the Markov chain for a random walk through W. By the Perron-Frobenius Theorem, it is known that the largest eigenvalue of A is one, and the corresponding eigenvector x is unique within a scaling factor. The vector field method (“VFM” in FIG. 2) discussed above is used to efficiently determine that eigenvector x.

When the scaling factor is chosen to be

$$\frac{1}{{Σ}_{i} {x}_{i}} ,$$

then x is the state vector of the Markov chain, and the elements of x are a useful metric of the importance of each page in W. It is believed that this eigenvector x is related to the PageRank feature used by www.Google.com to sort search results.

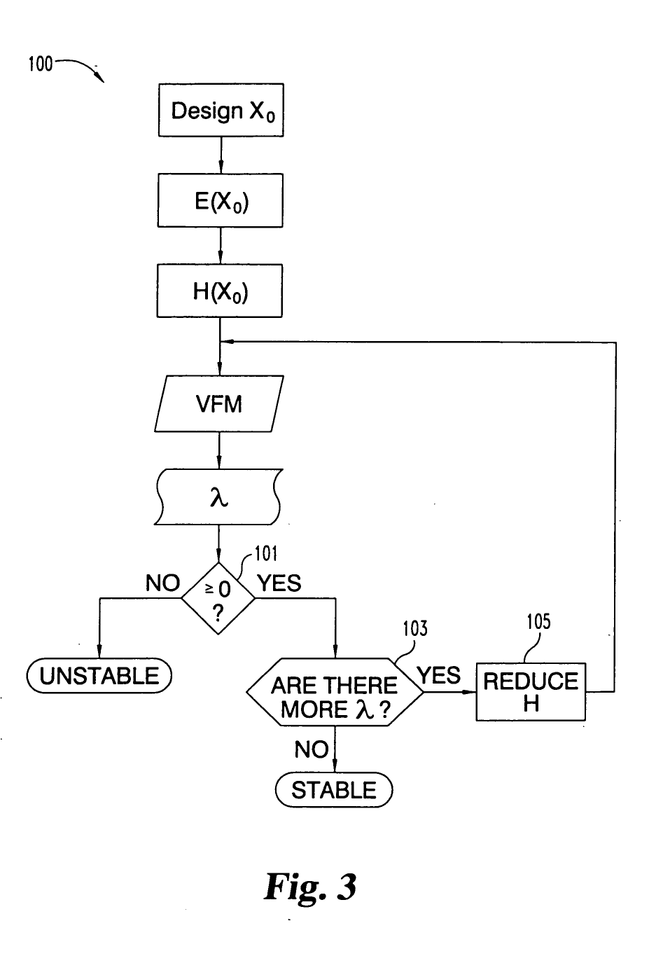

Another application of the inventive method of eigenvalue and eigenvector estimation is applied to structural stability analysis, as illustrated in FIG. 3 as process 100. Most engineering systems, such as a bridge, are described by a set of coordinates (such as the locations of the joints in a bridge), which here is collectively called X=(X₁; X₂; . . . ; Xₙ). In designing such systems it is desirable that the final configuration of the system to be a stable equilibrium—i.e., if perturbed slightly from the equilibrium by an external force (such as a strong wind for a bridge) the system should return to the equilibrium after the perturbation dies down. A system is in stable equilibrium if it is at the minimum of the potential energy.

Assume that the designed configuration of the system is X₀, and that one would like to determine if the configuration is in fact stable. Let E(X) denote the potential energy of the system. If we expand E(X) into its Taylor expansion we have

$$E ( X ) = E ( {X}_{0} ) + {[ ∇ E ( {X}_{0} ) ]}^{T} ( X - {X}_{0} ) + \frac{1}{2} [ {( X - {X}_{0} )}^{T} H ( {X}_{0} ) ( X - {X}_{0} ) ] + higher order terms$$

where H(X₀) is the Hessian matrix defined as

$$H ( {X}_{0} ) = [ \begin{matrix}\frac{{\partial }^{2} E}{\partial {X}_{1}^{2}} & \frac{{\partial }^{2} E}{\partial {X}_{1} \partial {X}_{2}} & … & \frac{{\partial }^{2} E}{\partial {X}_{1} \partial {X}_{n}} \\ ⋮ & ⋮ & & ⋮ \\ \frac{{\partial }^{2} E}{\partial {X}_{n} {X}_{1}} & \frac{{\partial }^{2} E}{\partial {X}_{n} \partial {X}_{2}} & … & \frac{{\partial }^{2} E}{\partial {X}_{n}^{2}}\end{matrix} ]$$

with all the partial derivatives evaluated at X₀. In order for X₀ to be a configuration of minimum potential energy, two conditions must be satisfied:

1. ∇E(X₀)=0, and

2. all of the eigenvalues of the Hessian matrix H(X₀) must be non-negative. The Hessian matrix is symmetric. The vector field method VFM is applied to the Hessian matrix to estimate an eigenvalue λ, which is compared to zero. If λ<0 (a negative result at the decision block 101), then it is concluded that the system X is unstable.

If, instead, λ>0, then it is determined at decision block 103 using techniques known to those skilled in the art whether any other eigenvalues remain to be found. If so (a positive result at block 103), H is reduced at block 105 and VFM is applied again. If not (a negative result at block 103), then it is concluded that the system X is stable.

A more generic system is system 150, illustrated in FIG. 4. There, matrix A is provided as input that is accepted by computer 152, which comprises a processor 154, memory 156, and storage 158. Memory 156 and/or storage 158 is encoded with programming instructions executable by the processor to provide estimated eigenvalues λ and eigenvectors x of A as output using the vector field method described above.

Although much of the discussion above was directed to systems represented by symmetric matrices, it will be understood by those skilled in the art that in alternative embodiments the invention is applied to systems that are represented by asymmetric matrices. This adaptation can be performed without undue experimentation by those of ordinary skill in the art.

Further, while certain examples of vector fields have been discussed herein, any vector field may be used in the present invention.

Further information that may be useful to one of ordinary skill in the art for background may be found in the following documents, where references in square brackets herein to documents by number refer to the corresponding reference number in this list:

[1] Arnoldi W. E. The principle of minimized iteration in the solution of the matrix eigenproblem. Quart. Appl. Math. 9 (1951) 17-29.

[2] Berry M. W., Dumais S. T. and Jessup E. R. Matrices, vector spaces and information retrieval. SIAM Rev. 41 (1999) 335-362.

[3] Berry M. W., Raghavan P. and Zhang X. Symbolic preprocessing technique for information retrieval using vector space models. Proc. of the first computational information retrieval workshop, SIAM (2000) 85-97.

[4] Chu M. T. and Funderlic R. E. The centroid decomposition: relationships between discrete variational decompositions and SVD. SIAM J. on Matrix Analysis and Applications, to appear.

[5] Cullum J. and Willoughby R. A. Lanczos Algorithms for Large Symmetric Eigenvalue Computations. Vol. I, Birkhaüser, Boston, Mass., 1985.

[6] Cullum J. and Willoughby R. A. Lanczos Algorithms for Large Symmetric Eigenvalue Computations. Vol. II, Birkhaüser, Boston, Mass., 1985.

[7] He W. and Prabhu N., A Vector Field Method for Computing Eigenvectors of Symmetric Matrices, in review.

[8] Cuppen J. J. M. A divide and conquer method for the symmetric eigenproblem. Numer. Math. 36 (1981) 177-195.

[9] Demmel J. W. Applied Numerical Linear Algebra. SIAM, Philadelphia, Pa., 1997.

[10] Bayer D. A., and Lagarias J. C., The nonlinear geometry of linear programming. I. Affine and projective scaling trajectories. Transactions of the AMS, 314:499-526, 1989.

[11] Bayer D. A., and Lagarias J. C., The nonlinear geometry of linear programming. II. Legendre transform coordinates and central trajectories. Transactions of the AMS, 314:527-581, 1989.

[12] Bayer D. A., and Lagarias J. C., The nonlinear geometry of linear programming. III. Projective Legendre transform coordinates and Hilbert geometry. Transactions of the AMS, 320:193-225, 1990.

[13] Morin T. L., Prabhu N. and Zhang. Z, Complexity of the Gravitational Method for Linear Programming, Journal of Optimization Theory and Applications, vol. 108, no. 3, pp. 635-660, 2001.

[14] Karmarkar N., A new polynomial time algorithm for linear programming, Combinatorica, 4, pp. 373-395, 1984.

[15] Bazaraa M S, Sherali H D and Shetty C M, Nonlinear programming: theory and algorithms, John Wiley and sons, 1993.

[16]J. Nocedal and S. J. Wright. Numerical optimization. Springer verlag, 1999.

[17] Dummit D., Foote R. and Holland R. Abstract Algebra. John Wiley and Sons, New York, N.Y., 1999.

[18] Frakes W. B. and Baeza-Yates R. Information retrieval: data structures and algorithms. Prentice Hall, 1992.

[19] Francis J. G. F. The QR transformation: a unitary analogue to the LR transformation. Parts I and II Comput. J. 4 (1961) 265-272, 332-345.

[20] Golub G. H. and van der Vorst H. A. Eigenvalue computation in the 20th century. J. Comput. Appl. Math. 123 (2000) 35-65.

[21] Golub G. H. and Van Loan C. F. Matrix Computations. The Johns Hopkins University Press, Baltimore, 1996.

[22] Gu M. and Eisenstat S. C. A divide-and-conquer algorithm for the symmetric tridiagonal eigenproblem. SIAM J. Matrix Anal. Appl. 16 (1995) 172-191.

[23] Householder A. S. The Theory of Matrices in Numerical Analysis. Dover, N.Y., 1964.

[24] Ikeji A. C. and Fotouhi F. An adaptive real-time web-search engine. In Proc. of the second international workshop on web information and data management, 12-16, Kansas City, Mo., USA, 1999.

[25] Jessup E. and Martin J. Taking a new look at the latent semantic analysis approach to information retrieval. Proc. of the first computational information retrieval workshop, SIAM (2000) 133-156.

[26] Kowalski G. Information retrieval system: theory and implementation. Kluwer Academic Publishers, 1997.

[27] Lanczos C. An iteration method for the solution of the eigenvalue problem of linear differential and integral operators. J. Res. Natl. Bur. Stand 45 (1950) 225-280.

[28] Lefshetz S. Differential equations: geometric theory. New York, Interscience publishers, 1963.

[29] Nash S. and Sofer A. Linear and nonlinear programming. McGraw-Hill, 1995.

[30] Parlett B. N. The Symmetric Eigenvalue Problem. Prentice-Hall, Englewood Cliffs, N.J., 1980.

[31] Pejtersen A. M. Semantic information retrieval. Communications of the ACM, 41-4 (1998) 90-92.

[32] Saad Y. Variations on Arnoldi's method for computing eigenelements of large unsymmetric matrices. Linear Algebra Appl. 34 (1980) 269-295.

[33] Stewart G. W. and Sun Ji-Guang, Matrix Perturbation Theory. Academic Press, San Diego, Calif., 1990.

[34] W. S. Burnside and A. W. Panton, The Theory of Equations. Dublin University Press Series, Dublin, Ireland, 1892.

[35] Trefethen L. N. and Bau D. III, Numerical Linear Algebra. SIAM, Philadelphia, Pa., 1997.

[36] Wilkinson J. H. The Algebraic Eigenvalue Problem. Clarendon Press, Oxford, 1965.

[37] Berry M. W., Dumais S. T. and O'Brien G. W., Using linear algebra for intelligent information retrieval, SIAM Review, 37: 573-595, 1995.

While the invention has been illustrated and described in detail in the drawings and foregoing description, the same is to be considered as illustrative and not restrictive in character, it being understood that only the preferred embodiments have been shown and described and that all changes and modifications that would occur to one skilled in the relevant art are desired to be protected. In addition, all patents, publications, prior and simultaneous applications, and other documents cited herein are hereby incorporated by reference in their entirety as if each had been individually incorporated by reference and fully set forth.

1. A system for processing symmetric matrices to estimate an eigenvector, comprising a processor and a computer-readable medium encoded with programming instructions executable to:
accept a first data structure that represents a matrix A of real numbers;
selecting a vector field V, where
V maps each point x on the unit sphere Sⁿ⁻¹ to a vector V(x) ∈ Tₓ, the tangent space to Sⁿ⁻¹ at x, and
V(x)=0 if and only if x is an eigenvector of A;
selecting a vector x₀ ∈ Sⁿ⁻¹;
iteratively determining xₖ₊₁ for k=0, 1, . . . (m−1) by
finding an α* that yields an optimal solution of
$$\begin{matrix}{max}_{α} {g}_{k} ( α ) := \frac{{( {x}_{k} + α V ( {x}_{k} ) )}^{T} A ( {x}_{k} + α V ( {x}_{k} ) )}{{‖ {x}_{k} + α V ( {x}_{k} ) ‖}^{2}} ; and \\ setting {x}_{k + 1} ← \frac{{x}_{k} + {α}^{*} V ( {x}_{k} )}{‖ {x}_{k} + {α}^{*} V ( {x}_{k} ) ‖} ; and\end{matrix}$$
outputting a second data structure that represents at least one of
xₘ and
λ,
where xₘ is an estimated eigenvector of A with corresponding estimated eigenvalue of λ.

2. The system of claim 1, wherein vector field V is a recursive vector field.

3. A method of determining the stability of a structural design, where H is the Hessian matrix H(x₀) of the potential energy function that characterizes a structural design x₀, comprising:
determining whether ∇E(x₀)=0, and if so, concluding that the design is unstable;
finding an eigenvalue λ of H(x₀), wherein the finding comprises iteratively determining xₖ₊₁ for k=0, 1, . . . (m−1) by:
finding an α* that yields an optimal solution of
$$\begin{matrix}{max}_{α} {g}_{k} ( α ) := \frac{{( {x}_{k} + α V ( {x}_{k} ) )}^{T} A ( {x}_{k} + α V ( {x}_{k} ) )}{{‖ {x}_{k} + α V ( {x}_{k} ) ‖}^{2}} ; and \\ setting {x}_{k + 1} ← \frac{{x}_{k} + {α}^{*} V ( {x}_{k} )}{‖ {x}_{k} + {α}^{*} V ( {x}_{k} ) ‖} ;\end{matrix}$$
if λ<0, concluding that the design is unstable;
if there are more eigenvalues of H, reducing H and repeating the finding step; and
if there are no more eigenvalues of H, concluding that the design is stable.

4. A method of ranking a plurality of interlinked hypertext documents W, comprising:
constructing a data structure that represents matrix A is the transition probability matrix of the Markov chain for a random walk through W;
applying a vector field method to determine the eigenvector x of A that corresponds to the largest eigenvalue of A; and
ranking the documents in W according to their corresponding values in x.
